(19) United States
(12) Patent Application Publication
(10) Pub. No.: US 2003/0174398 A1
(43) Pub. Date: Sep. 18, 2003

(54) Polarizing plate and its production method

(76) Inventors: Hideki Hayashi, Niihama-shi (JP); Narutoshi Hayashi, Niihama-shi (JP)

Correspondence Address: BIRCH STEWART KOLASCH & BIRCH, PO BOX 747, FALLS CHURCH, VA, 22040-0747, US

(21) Appl. No.: 10/372,788

(22) Filed: Feb. 26, 2003

(30) Foreign Application Priority Data
Mar. 12, 2002 (JP) 2002-066616

(51) Int. Cl. G02B 5/30; G02B 27/28

(52) U.S. Cl. 359/491; 359/500

(57) ABSTRACT

The object of the present invention is to provide an iodine type polarizing plate with improved durability and its production method. This object is achieved by providing an iodine type polarizing plate comprising a polyvinyl alcohol resin film in and on which iodine is adsorbed and oriented, and a protective film adhered to the polyvinyl alcohol resin film through a transparent adhesive layer which contains a water-soluble acrylic polymer selected from the group consisting of polyacrylic acid and its derivatives, and satisfying either of

A: the content of the water-soluble acrylic polymer in the polarizing plate being from 5 to 1,000 mg per 1 m² of the polarizing plate, or

B: the content of the water-soluble acrylic polymer in the transparent adhesive layer being from 2 to 75% by weight.

### FIELD OF THE INVENTION

The invention relates to a polarizing plate comprising a polyvinyl alcohol resin film in and on which iodine is adsorbed and oriented, and a protective film adhered to at least one surface of the polyvinyl alcohol resin film through an adhesive layer and its production method.

### BACKGROUND OF THE INVENTION

A polarizing plate is generally produced by adhering through an adhesive layer a protective film made of triacetylcellulose or the like to at least one surface of a polarizer made of a polyvinyl alcohol resin film in and on which iodine or a dichromatic dye as dichromatic coloring material is adsorbed and oriented. A polarizing film using iodine as the dichromatic coloring material is called as an iodine type polarizing film and a polarizing plate composed of such a film and a protective film adhered thereto is called as an iodine type polarizing plate. On the other hand, a polarizing film using dichromatic dye as the dichromatic coloring material is called as a dye type polarizing film and a polarizing plate comprising such a film and a protective film adhered thereto is called as a dye type polarizing plate. Between them, the iodine type polarizing plate has been widely used since it exhibits high transmittance, high polarization efficiency, that is, a high contrast, as compared with the dye type polarizing plate. Although the iodine type polarizing plate is superior as described above to the dye type polarizing plate in terms of optical characteristics, it is inferior to the dye type polarizing plate in terms of optical durability and, for example, when the iodine type polarizing plate is left under dry conditions at higher temperature, there occur problems of decreasing transmittance and changing color in the polarizing plate.

### SUMMARY OF THE INVENTION

Inventors of the present invention have made investigations in order to improving the durability of iodine type polarizing plate and completed the invention. Accordingly, the object of the present invention is to provide an iodine type polarizing plate having the good durability and further to provide its production method.

Inventors of the present invention have made investigation for such a purpose and consequently have found that the problem such as changing color under dry conditions at higher temperature can be efficiently suppressed by either using an adhesive containing a specified amount of polyacrylic acid or its derivatives for adhering an iodine type polarizing film and a protective film, or incorporating polyacrylic acid or its derivatives into an adhesive layer and controlling the amount of the acrylic acid or its derivatives in the entire polarizing plate to be specified amount and thus have completed the invention.

That is, the present invention provides an iodine type polarizing plate comprising a polyvinyl alcohol type resin film in and on which iodine is adsorbed and oriented, and a protective film adhered to the polyvinyl alcohol film through a transparent adhesive layer which contains a water-soluble acrylic type polymer selected from the group consisting of polyacrylic acid and its derivatives, wherein the content of the water-soluble acrylic type polymer in the polarizing plate is from 5 to 1,000 mg per 1 m² of the polarizing plate.

Also, the present invention provides an iodine type polarizing plate comprising a polyvinyl alcohol type resin film in and on which iodine is adsorbed and oriented, and a protective film adhered to the polyvinyl alcohol type resin film through a transparent adhesive layer which contains a water-soluble acrylic type polymer selected from the group consisting of polyacrylic acid and its derivatives, wherein the content of the water-soluble acrylic type polymer in the transparent adhesive layer is from 2 to 75% by weight of the adhesive layer.

Further, the present invention provides a method for producing an iodine type polarizing plate comprising the steps of

providing a polyvinyl alcohol type resin film in and on which iodine adsorbed and oriented, and

adhering a protective film to at least one surface of the polyvinyl alcohol type resin film through a transparent adhesive layer which contains a water-soluble acrylic type polymer selected from the group consisting of polyacrylic acid and its derivatives in an amount of from 2 to 75% by weight based on the entire solids contained in the adhesive.

### DETAILED DESCRIPTION OF THE PRESENT INVENTION

Hereinafter, the present invention will be described in detail. A polarizing plate according to the present invention is one that a protective film is adhered through an adhesive layer to at least one surface of so-called iodine type polarizing film, which is usually produced by uniaxially stretching a polyvinyl alcohol type resin film and making iodine adsorbed therein. In the present invention, a water-soluble acrylic type polymer is contained in the adhesive layer.

The water-soluble acrylic type polymer used in the present invention is polyacrylic acid or its derivatives. The polyacrylic acid derivatives include polyacrylic acid modified all or some carboxyl groups (—COOH) of the polyacrylic acid while keeping its water solubility. Examples include a polyacrylic acid salt such as sodium salt, especially a metal salt such as an alkali metal salt; polyacrolein having formyl group (—CHO) in place of carboxyl group; polyacrylamide having amido group (—CONH₂) in place of carboxyl group; polyacrylonitrile having cyano group (—CN) in place of carboxyl group; and the like. Further, the derivatives may include a water-soluble copolymer obtained by using two or more kinds of monomers selected from the monomers providing polyacrylic acid or its derivatives. Such monomers include acrylic acid, acrylic acid salts, acrolein, acrylamide, and acrylonitrile. A water-soluble copolymer of the present invention may include a water-soluble copolymer comprising one or more of these monomers, or that comprising other monomers copolymerizable with these monomers to the extent that the water solubility is not deteriorated. Among these water-soluble acrylic type polymers, polyacrylic acid is more preferable.

From one aspect of the embodiments, the content of the water-soluble acrylic type polymer in the polarizing plate of the present invention is from 5 to 1,000 mg per 1 m² of the polarizing plate. From another aspect of the embodiments, the content of the water-soluble acrylic type polymer in the adhesive layer is from 2 to 75% by weight. If the content of the water-soluble acrylic type polymer is less than the above lower limits, the effect of preventing the changing color under dry conditions at the higher temperature becomes insignificant and if the content is more than the above upper limits, the adhesive force of the adhesive layer becomes so weak that the protective film are not sufficiently adhered to the polarizing film.

The average molecular weight of the water-soluble acrylic type polymer is not necessarily limited, however, it is generally in a range of 1,000 to 6,000,000, preferably 1,500 to 1,000,000, and more preferably 5,000 to 250,000, by weight average molecular weight.

The polyvinyl alcohol used for the polarizing film of the present invention is generally obtained by saponifying polyvinyl acetates. The polyvinyl acetates may include polyvinyl acetate, which is a homopolymer of vinyl acetate, and copolymers of vinyl acetate and other monomers copolymerizabie with vinyl acetate. Other monomers copolymerizable with vinyl acetate include, for example, unsaturated carboxylic acids, olefins, vinyl ethers, unsaturated sulfonic acids, and the like. The saponification degree of the polyvinyl alcohol is generally 85 to 100% by mole, preferably 98 to 100% by mole. The polyvinyl alcohol may be further modified and, for example, those modified by aldehydes such as polyvinyl formal and polyvinyl acetal may be used. The polymerization degree of polyvinyl alcohol is generally in a range of 1,000 to 10,000, preferably 1,500 to 5,000.

The iodine type polarizing plate is generally produced by steps of uniaxially stretching such a polyvinyl alcohol type resin film, adsorbing iodine by dying the polyvinyl alcohol type resin film with iodine, treating the polyvinyl alcohol type resin film adsorbing iodine with an aqueous boric acid solution, washing the film with water after the treatment with the aqueous boric acid solution, and adhering a protective film to at least one surface of the resulting stretched polyvinyl alcohol type resin film.

The uniaxial stretching may be carried out before or simultaneously with or after dyeing with iodine. In the case the uniaxial stretching is carried out after dyeing with iodine, the uniaxial stretching may be carried out before the treatment with boric acid or during the treatment with boric acid. Of course, the uniaxial stretching can be carried out in a plurality of these steps. To carry out uniaxial stretching, the stretching may be carried out uniaxially between rolls with different peripheral speeds or by using hot rolls. Further, the stretching may be so-called dry stretching in which a film is stretched in atmospheric air or so-called wet stretching in which a film is swollen with a solvent and stretched. The stretching ratio is generally from 4 to 8 times.

The method for adsorbing and orienting iodine in and on the polyvinyl alcohol type resin film is usually a method of immersing polyvinyl alcohol type resin film in an aqueous solution containing iodine and potassium iodide. The content of iodine in the aqueous solution is generally from 0.01 to 0.5 parts by weight in 100 parts by weight of water and the content of potassium iodine is generally from 0.5 to 10 parts by weight in 100 parts by weight of water. The temperature of the aqueous solution is generally from about 20 to 40° C. and the immersion time in the aqueous solution is generally from about 30 to 300 seconds.

The treatment with boric acid after the dyeing with iodine is carried out by immersing the polyvinyl alcohol type resin film dyed with iodine in an aqueous boric acid solution. The content of boric acid in the aqueous boric acid solution is generally from about 2 to 15 parts by weight, preferably from 5 to 12 parts by weight, in 100 parts by weight of water. The aqueous boric acid solution is preferable to contain potassium iodide. The immersion time in the aqueous boric acid solution is generally from about 100 to 1,200 seconds, preferably from 150 to 600 seconds, more preferably from 200 to 400 seconds.

The polyvinyl alcohol type resin film after the treatment with boric acid is generally washed in water. The washing with water is carried out by, for example, immersing the polyvinyl alcohol type resin film treated with boric acid in water. After the washing with water, drying treatment is carried out to obtain a polyvinyl alcohol type resin film in which iodine is adsorbed and oriented, that is, an iodine type polarizing film.

The polarizing film obtained in such a manner is made to be a polarizing plate by adhering a protective film to one surface or both surfaces of the film. The protective film includes, for example, a cellulose acetate resin film of such as triacetylcellulose, diacetylcellulose; an acrylic resin film; a polyester resin film; a polyarilate film; a polyether sulfone resin film; a cyclic polyolefin resin film comprising a cyclic olefin as a monomer such as norbornene and the like. The thickness of the protective film is generally from 30 to 200 μm.

Adhesive used for adhering the protective film is a transparent adhesive and optically isotropic adhesive is preferably used. In the present invention, a water-soluble acrylic type polymer as described above is added in the adhesive so as to make 5 to 1,000 mg of the water-soluble acrylic type polymer exist per 1 m² of the polarizing plate. The content of the water-soluble acrylic type polymer per 1 m² of the polarizing plate is preferably 25 mg or more and preferably 500 mg or less. In the case of adhering a protective film to both surfaces of the polarizing film through an adhesive layer, the amount of the water-soluble acrylic type polymer per 1 m² of the polarizing plate is the total amount of the polymer existing in both layers. The amount of the water-soluble acrylic type polymer contained in the adhesive is from 2 to 75% by weight based on the amount of total solids contained in the adhesive. The amount of the water-soluble acrylic type polymer is preferably 10% by weight or more and preferably 60% by weight or less, base on the amount of total solids contained in the adhesive.

The transparent adhesive may include, for example, polyvinyl alcohol type adhesives, acrylic type adhesives, urethane type adhesives and the like, however, it is not necessarily restricted to them. Preferable polyvinyl alcohol type adhesives among them may be partially saponified polyvinyl alcohol and completely saponified polyvinyl alcohol and besides them, aqueous solutions of modified polyvinyl alcohol type resin such as acetoacetyl-modified polyvinyl alcohol, carboxyl-modified polyvinyl alcohol, and the like. Further, they may contain a cross-linking agent such as a water-soluble epoxy compound, a dialdehyde, and an isocyanate. The adhesive may be an emulsion. As a solvent of the adhesive, water is preferable, however, a slight amount of a hydrophilic organic solvent, for example, alcohols and the like, may be added.

To add the water-soluble acrylic type polymer to the adhesive, a method by adding a water-soluble acrylic type polymer to an adhesive and producing the adhesive containing the water-soluble acrylic type polymer is most simple.

Generally, after adhering the protective film to the polarizing film through the adhesive, drying is carried out to remove the solvent and obtain a polarizing plate. The drying is generally carried out by hot air drying and at that time, the temperature is properly selected in a range of about 40 to 100° C., preferably 45 to 90° C. The drying time is generally from about 20 to 1,200 seconds. The thickness of the adhesive layer after drying is generally from 0.01 to 4 μm, preferably from 0.05 to 2 μm, however, it is not necessarily limited to these ranges.

In the polarizing plate of the present invention, it is necessary to make a water-soluble acrylic type polymer exist in the adhesive layer, however, a water-soluble acrylic type polymer may exist in other layers and, for example, it allows an embodiment in which a small amount of a water-soluble acrylic type polymer is added to a polarizer comprising the polyvinyl alcohol type resin as described above and the protective film is adhered to the polarizer through an adhesive containing a water-soluble acrylic type polymer. From the viewpoint of the complication of controlling the concentration of a boric acid in the boric acid treatment bath employed after dyeing with iodine, it is advantageous that the water-soluble acrylic type polymer existing in the polarizing plate is entirely contained in the adhesive.

The polarizing plate obtained-in such a manner may have a hard coating layer, a reflection prevention layer, an anti-glare layer and the like on the surface. Further, generally, an adhesive layer is formed in at least one surface of the above-mentioned polarizing plate.

### EXAMPLES

Hereinafter, the invention will be described with reference to examples, however, the invention is not limited to these examples. Incidentally, crossed hue means the hue of transmitted light when polarized light orthogonally crossing the transmittance axis of the polarizing plate comes in the polarizing plate.

### Example 1

A polyvinyl alcohol type resin film, which was made of polyvinyl alcohol having an average polymerization degree of about 2,400 and a saponification degree of 99.9% by mole, with a thickness of 75 μm was uniaxially stretched 5 times of stretching ratio in the manner of so-called dry stretching and while being kept in stretched state, the resulting film was immersed in an aqueous solution having 0.05/5/100 ratio as iodine/potassium iodine/water ratio by weight at 28° C. for 60 seconds. Next, the film was immersed in an aqueous solution having 10/9.5/100 ratio as potassium iodide/boric acid/water ratio by weight at 74° C. for 300 seconds. After the film was washed with pure water at 26° C. for 20 seconds, it was dried at 65° C. to obtain a polarizing film of polyvinyl alcohol in and on which iodine was adsorbed and oriented. The thickness of the obtained polarizing film was about 26 μm.

On the other hand, polyacrylic acid with a weight average molecular weight of about 250,000 was added to an aqueous solution containing polyvinyl alcohol with an average polymerization degree of 1,700 and a saponification degree of 99.6% or more by mole to obtain an adhesive having weight ratio of polyvinyl alcohol/polyacrylic acid/water of 4/2/100. The weight ratio of the polyacrylic acid to the total solids in the adhesive was ⅓. After the adhesive was applied to both surfaces of the polarizing film obtained above, a protective film (“Konica Tack KC8OUVSHF”, obtained from Konica Corporation) with a thickness of 80 μm and made of surface-saponified triacetylcellulose was adhered to the both surfaces of the polarizing film. Then, the resulting laminated film was dried at 50° C. for 25 minutes to obtain a polarizing plate.

The total thickness of the adhesive layers adhered to both surfaces in the polarizing plate was about 0.33 μm. That is, the polarizing plate contained about 140 mg of polyacrylic acid per 1 m² surface area. The crossed hue b* of the polarizing plate as obtained above was measured by the UV-visible ray spectrum. Next, after the polarizing plate was left at 100° C. in dry atmosphere for 14 hours, the crossed hue b* of the polarizing plate was measured by the UV-visible spectrum again. The difference Δb* of the crossed hue b* that is the difference of the crossed hue b* after the drying and heating test from the crossed hue b* before the drying and heating test was calculated and the result was shown in Table 1.

### Example 2

A polarizing plate was produced in the same manner as described in Example 1, except that the polyacrylic acid was changed to one having a weight average molecular weight of about 5,000 from about 250,000. The obtained polarizing plate was evaluated by the same manner as described in Example 1 and the result was shown in Table 1.

### Comparative Example 1

A polarizing plate was produced in the same manner as described in Example 1, except that no polyacrylic acid was used. The obtained polarizing plate was evaluated by the same manner as described in Example 1 and the result was shown in Table 1.

TABLE 1

| | | Average | |
|---|---|---|---|
| | Polyacrylic | molecular | Crossed hue difference |
| | acid amount in | weight of | before and after drying |
| Example | adhesive | polyacrylic acid | and heating test Δb* |
| Example 1 | 1/3 | 250,000 | 6.44 |
| Example 2 | 1/3 | 5,000 | 8.44 |
| Comparative | — | — | 10.52 |
| Example 1 | | | |

An iodine type polarizing plate of the present invention did not show significant deterioration after being left under dry condition at higher temperature and was excellent in durability.

What is claimed is;

1. An iodine type polarizing plate comprising a polyvinyl alcohol resin film in and on which iodine is adsorbed and oriented, and a protective film adhered to the polyvinyl alcohol resin film through a transparent adhesive layer which contains a water-soluble acrylic type polymer selected from the group consisting of polyacrylic acid and its derivatives, and satisfying either of
A: the content of the water-soluble acrylic polymer in the polarizing plate being from 5 to 1,000 mg per 1 m² of the polarizing plate, or
B: the content of the water-soluble acrylic polymer in the transparent adhesive layer being from 2 to 75% by weight.

2. The iodine type polarizing plate according to claim 1, wherein the water-soluble acrylic polymer is entirely contained in the adhesive layer.

3. The iodine type polarizing plate according to claim 1, wherein the protective film is adhered to the both surfaces of the polyvinyl alcohol resin film.

4. The iodine type polarizing plate according to claim 1, wherein the adhesive layer comprises polyvinyl alcohol adhesives.

5. The iodine type polarizing plate according to claim 1, wherein the polyacrylic acid and its derivatives are selected from the group consisting of a polyacrylic acid, polyacrylic acid salt, polyacrolein, polyacrylamide and polyacrylonitrile.

6. The iodine type polarizing plate according to claim 1, wherein the content of the water-soluble acrylic polymer in the polarizing plate is 25 mg or more per 1 m² of the polarizing plate.

7. The iodine type polarizing plate according to claim 1, wherein the content of the water-soluble acrylic polymer in the polarizing plate is 500 mg or less per 1 m² of the polarizing plate.

8. A method for producing an iodine type polarizing plate comprising the steps of
providing a polyvinyl alcohol resin film in and on which iodine adsorbed and oriented, and
adhering a protective film to at least one surface of the polyvinyl alcohol resin film through a transparent adhesive layer which contains a water-soluble acrylic polymer selected from the group consisting of polyacrylic acid and its derivatives in an amount of 2 to 75% by weight based on the entire solids of the adhesive.
